(19) United States
(12) Patent Application Publication
(10) Pub. No.: US 2019/0147626 A1
(43) Pub. Date: May 16, 2019

(54) SYSTEMS AND METHODS FOR ENCODING FEATURES OF A THREE-DIMENSIONAL VIRTUAL OBJECT USING ONE FILE FORMAT

(71) Applicant: Tsunami VR, Inc., Del Mar, CA (US)

(72) Inventors: Morgan Nicholas GEBBIE, Carlsbad, CA (US); David ROSS, San Diego, CA (US); Kyle RUSSELL, Alameda, CA (US)

(21) Appl. No.: 16/178,435

(22) Filed: Nov. 1, 2018

Related U.S. Application Data
(60) Provisional application No. 62/580,132, filed on Nov. 1, 2017.
(60) Provisional application No. 62/593,071, filed on Nov. 30, 2017.

(51) Int. Cl. G06T 9/00; G06T 1/00; G06K 9/46

(52) U.S. Cl. CPC G06T 9/001; G06K 9/46; G06T 1/005

(57) ABSTRACT

Systems, methods, and computer readable media for encoding features of a three-dimensional (3D) virtual object are provided. The method can include receiving an indication of one or more features of a plurality of features required for rendering the virtual object at a user device communicatively coupled to the server. The method can include applying, by the server, security levels to the plurality of features, the security levels comprising one or more encryption types. The method can include encoding a data file based on the indication and the security levels, the file including data related to multiple resolution levels of the one or more features. The method can include causing the virtual object to be rendered at the user device based on the file and operating characteristics of the user device.

### CROSS REFERENCE TO RELATED APPLICATIONS

This application claims priority to U.S. Provisional Patent Application Ser. No. 62/580,132, filed Nov. 1, 2017, entitled “SYSTEMS AND METHODS FOR ENCODING FEATURES OF A THREE-DIMENSIONAL VIRTUAL OBJECT USING ONE FILE FORMAT,” and U.S. Provisional Patent Application Ser. No. 62/593,071, filed Nov. 30, 2017, entitled “SYSTEMS AND METHODS FOR ENCODING FEATURES OF A THREE-DIMENSIONAL VIRTUAL OBJECT USING ONE FILE FORMAT,” the contents of which are hereby incorporated by reference in their entirety.

### BACKGROUND

### Technical Field

This disclosure relates to virtual reality (VR), augmented reality (AR), and hybrid reality technologies.

### Related Art

Mixed reality (MR), sometimes referred to as hybrid reality, is the term commonly applied to the merging of real or physical world and virtual worlds to produce new environments and visualizations where physical and digital objects co-exist and interact. Mixed reality visualizations and environments can exists in the physical world, the virtual world, and can include a mix of reality, VR, and AR via immersive technology including interactive environments and interactive three-dimensional (3D) virtual objects.

Interactive 3D virtual objects can be complex and contain large amounts of information that describe different features of the virtual objects, including the geometry, appearance, scenery, and animation of the virtual objects. Particular features of a virtual object may include shape, surface geometry, color, texture, material type, light sources, cameras, peripheral objects, animation, physical properties, and kinematics. As virtual objects become more complex by integrating more features, encoding and transferring all features of a virtual object between applications becomes increasingly difficult when multiple files are used to provide details about different features of the virtual object. Some approaches for encoding different features of a virtual object may use multiple file formats where a first feature is encoded using a first format, and a second feature is encoded using a second format. Examples of existing file formats include: STL, OBJ, FBX, COLLADA, 3DS, IGES, STEP, X3D and others.

### SUMMARY

An aspect of the disclosure provides a method for encoding features of a three-dimensional (3D) virtual object. The method can include receiving an indication of one or more features of a plurality of features required for rendering the virtual object at a user device communicatively coupled to the server. The method can include applying, by the server, security levels to the plurality of features, the security levels comprising one or more encryption types. The method can include encoding a data file based on the indication and the security levels, the file including data related to multiple resolution levels of the one or more features. The method can include causing the virtual object to be rendered at the user device based on the file and operating characteristics of the user device.

Another aspect of the disclosure provides a non-transitory computer-readable medium comprising instructions for encoding features of a three-dimensional (3D) virtual object. When executed by one or more processors the instructions cause the one or more processors to receive an indication of one or more features of a plurality of features required for rendering the virtual object at a user device communicatively coupled to the server. The instructions can further cause the one or more processors to apply security levels to the plurality of features. The security levels can have one or more encryption types. The instructions can further cause the one or more processors to encode a data file based on the indication and the security levels. The file can have data related to multiple resolution levels of the one or more features. The instructions can further cause the one or more processors to cause the virtual object to be rendered at the user device based on the file and operating characteristics of the user device.

Other features and benefits will be apparent to one of ordinary skill with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1 is a functional block diagrams of embodiments of a system for transmitting files associated with a virtual object to a user device;

FIG. 2 is a functional block diagram of the user devices of FIG. 1;

FIG. 3 is a graphical depiction of simplified three dimensional objects for display in a virtual environment; and

FIG. 4 is a flowchart of a method for encoding features of a three-dimensional virtual object using one file format.

### DETAILED DESCRIPTION

Importing and exporting multiple files between VR servers and end users or user devices can be inefficient and may require many file conversions to allow proper rendering of the virtual environment and objects. Each file may have a different extension and encoding format that may or may not be accessible by all operating systems and applications, or that may be designed and optimized to work better with certain software applications while working less than optimally with other applications (if at all). Multiple files can be encoded using different codes, separately transmitted, and decoded using different codecs. Different files often have to be reformatted into other file types before they can be used. Use of different codecs, separate transmission of files, and reformatting files detrimentally increases processing inefficiency, and can restrict use of the files until all files have been transmitted, decoded and reformatted. Exporting files is similarly inefficient. In some cases, a codec may be proprietary and needs to be purchased or otherwise obtained, which increases cost. Also, since different file formats offer different levels of security (or no security at all), using different file formats to transmit different features of the same virtual object limits the type of security that can be applied to a feature, limits application of universal security measures to protect different data describing different features, and/or limits application of different levels of security for different features based on user preference. Since information may undergo decimation, or other sampling rate reductions or conversions (e.g., downsampling), use of different file formats make it difficult to wrap security in the file at each levels of decimation.

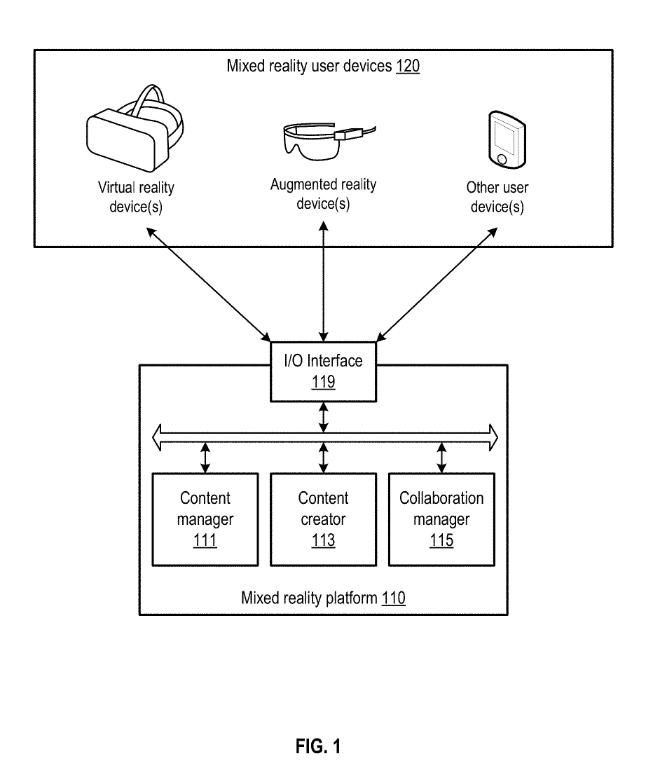

Instead of using multiple files that each contain different feature(s) of a virtual object, this disclosure describes systems and method for creating, transmitting and using one file that contains all of the features of the virtual object in one format. The file can be decimated based on capabilities of a user device (e.g., the user device 120 of FIG. 1), or preferences of a user. Improved security measures are used to protect data in the file, including individual security applied to data of particular features, and security applied to the file. A neutral file format for objects that is capable of encoding all features of a 3D virtual object into a single file is highly desirable for enterprise industries (e.g., manufacturing and design industries) that seek efficient and secure file management and distribution across a network of users.

This disclosure is related to U.S. patent application Ser. No. 16/171,051, filed Oct. 25, 2018, entitled, “SYSTEMS AND METHODS FOR ENABLING DISPLAY OF VIRTUAL INFORMATION DURING MIXED REALITY EXPERIENCES,” U.S. patent application Ser. No. 16/175,384, filed Oct. 30, 2018, entitled, “SYSTEMS AND METHODS FOR DETERMINING WHEN TO PROVIDE EYE CONTACT FROM AN AVATAR TO A USER VIEWING A VIRTUAL ENVIRONMENT,” U.S. patent application Ser. No. 16/175,545, filed Oct. 30, 2018, entitled, “SYSTEMS AND METHODS FOR USING A CUTTING VOLUME TO DETERMINE HOW TO DISPLAY PORTIONS OF A VIRTUAL OBJECT TO A USER,” U.S. patent application Ser. No. 16/175,505, filed Oct. 30, 2018, entitled, “SYSTEMS AND METHODS FOR TRANSMITTING FILES ASSOCIATED WITH A VIRTUAL OBJECT TO A USER DEVICE BASED ON DIFFERENT CONDITIONS,” U.S. patent application Ser. No. 16/177,082, filed Oct. 31, 2018, entitled, “SYSTEMS AND METHODS FOR DETERMINING HOW TO RENDER A VIRTUAL OBJECT BASED ON ONE OR MORE CONDITIONS,” and U.S. patent application Ser. No. 16/177,131, filed Oct. 31, 2018, entitled, “SYSTEMS AND METHODS FOR ADDING NOTATIONS TO VIRTUAL OBJECTS IN A VIRTUAL ENVIRONMENT,” the contents of which are hereby incorporated by reference in their entirety.

Attention is now drawn to the description of the figures below.

FIG. 1 is a functional block diagrams of embodiments of a system for transmitting files associated with a virtual object to a user device. The transmitting can be based on different conditions and can provide the virtual environments as an immersive experience for VR and AR users. The system includes a mixed reality platform 110 that is communicatively coupled to any number of mixed reality user devices 120 such that data can be transferred between them as required for implementing the functionality described in this disclosure. The platform 110 can be implemented with or on a server. General functional details about the platform 110 and the user devices 120 are discussed below before particular functions involving the platform 110 and the user devices 120 are discussed.

As shown in FIG. 1, the platform 110 includes different architectural features, including a content manager 111, a content creator 113, a collaboration manager 115, and an input/output (I/O) interface 119. The content creator 111 creates a virtual environment and visual representations of things (e.g., virtual objects and avatars) that can be displayed in a virtual environment depending on a user's point of view. Raw data may be received from any source, and then converted to virtual representations of that data. Different versions of a virtual object may also be created and modified using the content creator 111. The content manager 113 stores content created by the content creator 111, stores rules associated with the content, and also stores user information (e.g., permissions, device type, or other information). The collaboration manager 115 provides portions of a virtual environment and virtual objects to each of the user devices 120 based on conditions, rules, poses (e.g., positions and orientations) of users in a virtual environment, interactions of users with virtual objects, and other information. The I/O interface 119 provides secure transmissions between the platform 110 and each of the user devices 120. Such communications or transmissions can be enabled by a network (e.g., the Internet) or other communication (local or otherwise) link coupling the platform 110 and the user device(s) 120.

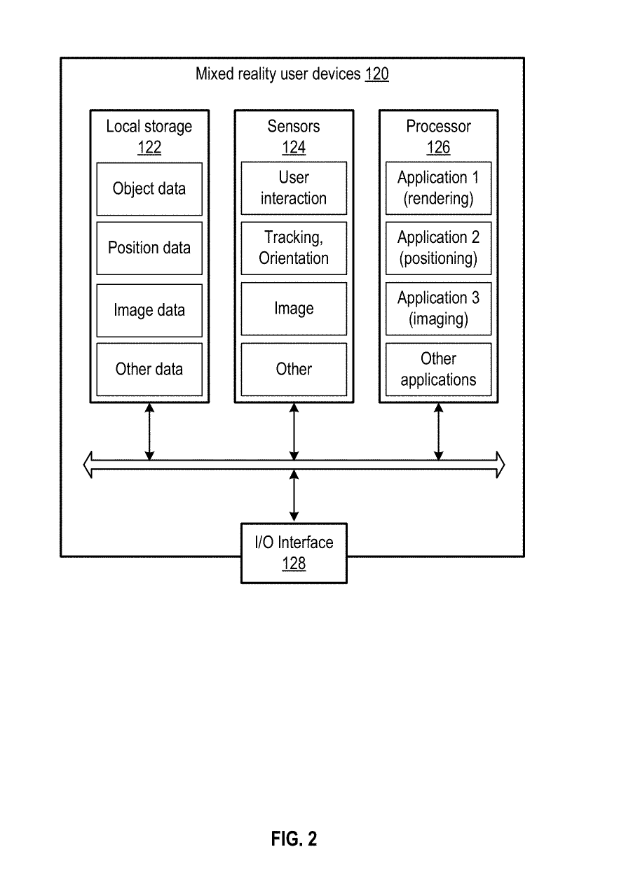

FIG. 2 is a functional block diagram of the user devices of FIG. 1. Each of the user devices 120 include different architectural features, and may include the features shown in FIG. 2, including a local storage 122, sensors 124, processor(s) 126, and an input/output interface 128. The local storage 122 stores content received from the platform 110, and information collected by the sensors 124. The processor 126 runs different applications needed to display any virtual object or virtual environment to a user operating a user device. Such applications include rendering, tracking, positioning, 2D and 3D imaging, and other functions. The I/O interface 128 from each user device 120 manages transmissions between that user device 120 and the platform 110. The sensors 124 may include inertial sensors that sense movement and orientation (e.g., gyros, accelerometers and others), optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of such peripherals include head-mounted displays, AR glasses, and other peripherals.

Some of the sensors 124 (e.g., inertial, optical, and location sensors) are used to track the pose (e.g., position and orientation) of a user in virtual environments and physical environments. Tracking of user position and orientation (e.g., of a user head or eyes) is commonly used to determine view areas, and the view area is used to determine what virtual objects to render using the processor 126 for presentation to the user on a display of a user device. Tracking the positions and orientations of the user or any user input device (e.g., a handheld device) may also be used to determine interactions with virtual objects. In some embodiments, an interaction with a virtual object includes a modification (e.g., change color or other) to the virtual object that is permitted after a tracked position of the user or user input device intersects with a point of the virtual object in a geospatial map of a virtual environment, and after a user-initiated command is provided to make the desired modification.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual objects among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images.

Examples of the user devices 120 include VR, AR, and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

The methods or processes outlined and described herein and particularly those that follow below, can be performed by one or more processors of the platform 110 either alone or in connection or cooperation with the user device(s) 120. The processes can also be performed using distributed or cloud-based computing.

### Encoding a Three-Dimensional Virtual Object Using One File Format

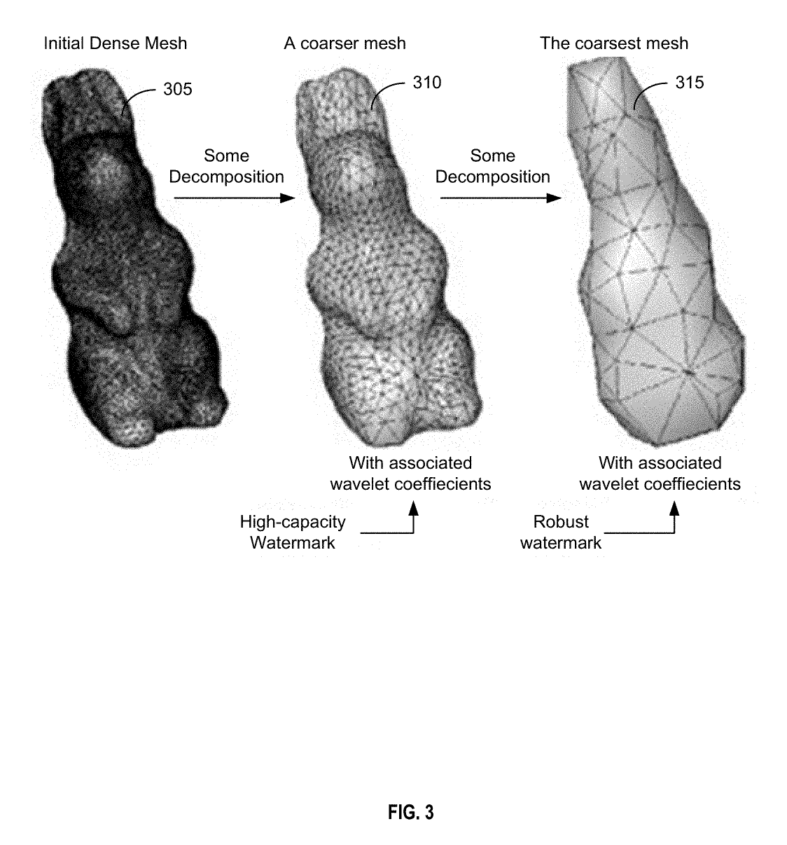

FIG. 3 is a graphical depiction of simplified three dimensional objects for display in a virtual environment. FIG. 3 shows different views or versions of a three dimensional rendering of a virtual object, a rabbit. As shown, the density of the details of the initial dense mesh 305 is the highest, having a series of densely packed polygons approximating the surface of the virtual object. The mesh as used herein refers to the arrangement of various polygons to describe the surface of the virtual object. A coarser mesh 310 has less dense polygons describing the outer surface of the virtual object (e.g., the rabbit). The coarser mesh 310 approximates the dense mesh 305 into a less precise approximation (e.g., down sampled version) of the virtual object. The coarser mesh 310 can be produced by one or more decimation processes performed on the initial dense mesh 305, for example. A third, and least precise approximation or coarsest mesh 315 takes the approximations of the coarser mesh 310 further, for the least precise approximation of the virtual object. Three exemplary versions of the virtual object are shown for illustrative purposes, but this is not limiting on the disclosure. Any number of approximations for surface resolution, or other factors or features described herein, are possible. These approximations can provide a reduction in, for example, resolution that may be needed for display on some user devices 120.

As mentioned above, virtual objects such as the rabbit of FIG. 3, can have different features—e.g., geometry, appearance, scenery, animation, and others. Particular features include: geometry (approximate meshes using triangles or polygons, precise meshes using non-uniform rational basis spline (NURBS), shape, surface geometry, constructive solid geometry (CSG)); appearance (color, texture, material, face attribute values); scenery (lighting angles and intensity, tint, cameras, spatial relationships between objects, peripheral objects, scenery); and animation (kinematics, physical properties, movement). By way of example, geometric meshing and CSG capture the shape and surface details of a 3D virtual object. Texture mapping applies textures onto certain portions of the virtual object. A color palette paints an object with color so it is not displayed in gray and white. Skeletal animation specifies animation and any movement of a virtual object, which can be encoded, transmitted, and later decoded so animation does not have to be created after a virtual object is imported. Particular embodiments of the single file can encode each of the above features into a single file, transfer the single file, and decode the single file to access the data of each encoded feature.

Decimation is also a key attribute in the single file's encoding functionality. Information in files (e.g., the single files) can be easily decimated for users without access to large processing capabilities. This optimizes the accessibility and experience of users importing and viewing the single files. In some embodiments, every level of decimation from coarse to detailed resolution contains a level of security to ensure the safety of file information through each level of decimation. The three leaves of geometric meshing of FIG. 3 is an example of the decimation, or reduction in sampling rate of certain aspects of the representation or rendering of the virtual object or rabbit.

In some embodiments, a single file includes features for CAD files (e.g., geometry, composition, hierarchy, materials, color textures, baked lighting, and others), while also capable of including features CAD formats do not support. In some embodiments, any of the following features are included in a single file: animations (method and instructions for animating the object, animated materials); interaction definition (object or component behavior when user manipulates the object); embedded meta data (notes from creator or designers, trademarks or copyrights); component-level security for particular components of the object; reduction of quality instructions (method and instructions for auto-generating a reduced quality version of the object from a higher quality version of the object); creator customizable meta data; and/or an identifier (e.g., Universal Product Code) of a physical item represented by the virtual object.

By way of example, when creating a single file, geometric data like approximate triangular meshes as well as other polygon structures is encoded. The encoded information maps a virtual object and transfers information about approximate and precise meshes (e.g., FIG. 3). Approximate mesh data may include vertexes and normal vectors. Precise meshes can be supported by NURBS and CSG. Color and texture mapping is also encoded into available data of the file. Such mapping allows color and textures to be processed and stored in the same file as the geometric data. Skeletal information and data specifying how the virtual object is allowed to move is also encoded. Code (e.g., C++ code) can be created for the file, allowing different operating systems to open and interact with the file.

In some embodiments, the format of the single file includes sections of data (e.g., segments), where each section includes code for a particular feature or a group of features, and each section of data is independently streamed in a definable order such that each section is separately loadable by different types of devices (e.g., the user device 120) that each receive the single file (e.g., phones, desktop computers, VR devices, AR devices, or other devices). In one embodiment, each section has a unique identifier, optionally has a unique link, and optionally has a hierarchy. In one embodiment, some sections of data include switch nodes for selecting from among different levels of detail or different characteristics of a feature that are separately and selectively loadable by different types of devices or different users depending on the capabilities of each device or the permissions of each user.

Having separate sections of data per feature (e.g., animation, materials, geometry) and having selectable levels of detail or different characteristics of a feature within particular sections allows for display of more versions of a virtual object than what is possible with prior approaches. For example, animation can now be connected to a part of a virtual object independent of level of detail that is also connected to that part of the virtual object such that selection of a lower level of detail does not preclude animation of the part at the lower level of detail. When some past approaches are used, animation is lost when the highest level of detail does not display. Having separate sections of data and selectable levels of detail or different characteristics of a feature within particular sections allows for animation to be shown so long as the displayed level of detail results in display of the part that is to be animated. For instance, if parts of a virtual object to be displayed include a moving hand with moving fingers, and if a 3D VR device (e.g., the user device 120) can display a first level of detail showing the fingers and hand while a 2D phone device can display of second level of detail showing the hand but not the fingers, then animation of the hand is shown on both the 3D device and the 2D device, but the animation of the fingers is only shown on the 3D device. In prior approaches, the animation of the hand on the 2D may not have been possible.

Having selectable levels of detail or different characteristics of a feature within particular sections allows for controlling how a virtual object can be viewed or modified, and for reducing amounts of transmitted data to only the levels of detail or different characteristics that are needed for particular circumstances. For instance, in some embodiments, characteristics of a part of a virtual object can be restricted by a user to particular colors, level of detail, or other characteristics, where the particular characteristics are stored in the single file as options that are selectable by a device using a switch node in the file such that one color, level of detail, or value of another characteristic is viewable on the device at a time. In some prior approaches, no such restrictions are possible, which results in sending more data than is necessary.

Having separate sections of data allows for application of security on a per-section basis (e.g., using encryption key technology per section), security on a group-of-sections basis (e.g., using encryption key technology per groups of sections), and security on a file basis (e.g., using encryption key technology per file). In some embodiments, a user selects parts of an object to encrypt, selects the entire object to encrypt, or selects a level of detail or a different characteristic of a feature of the virtual object to encrypt. The selected thing is encrypted independent of other things, later decrypted (e.g., where encryption and decryption can use known techniques of encryption/decryption).

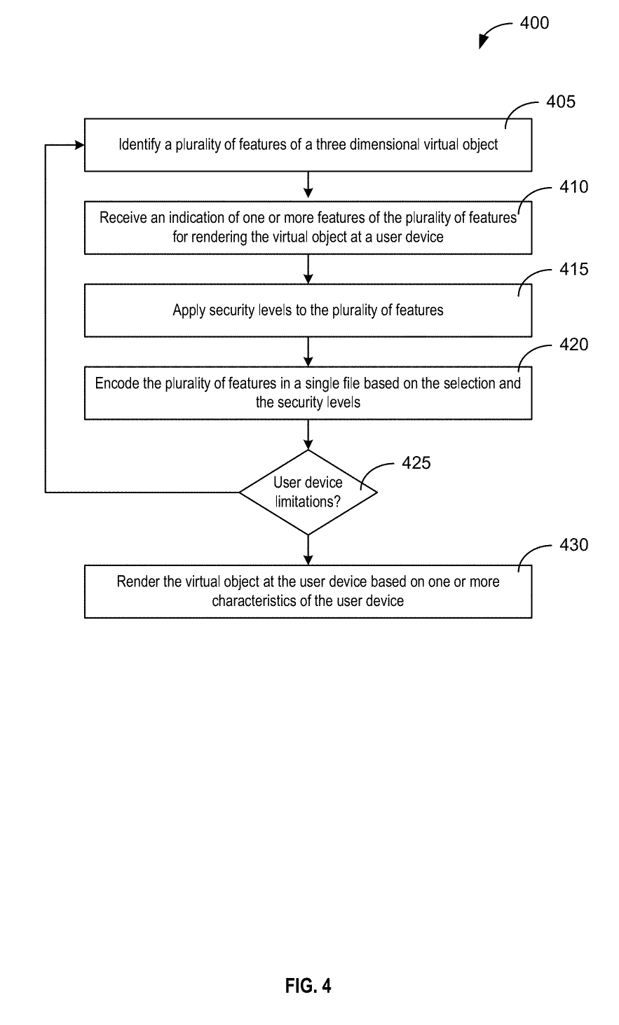

FIG. 4 is a flowchart of a method for encoding features of a three-dimensional virtual object using one file format. A method 400 can begin with the (405) identification of a plurality of features of a three-dimensional virtual object. In an embodiment of the method 400, the plurality of features can include geometry, appearance, scenery, and animation features of the virtual object. In other embodiments, the plurality of features include an approximate mesh, a precise mesh, constructive solid geometry, color, texture, material, lighting information, scenery, kinematics, and movement. In another embodiment of the method 400, different levels of security are applied to at least two different features.

The method 400 can include (410) receiving an indication of one or more of the plurality of features based on the user device. In some embodiments, the indication can include a selection from a user at the user device 120. For example, the user can specify particular characteristics or features desired in the ultimate rendering of the virtual object at the user device 120. In other embodiments, the indication can include information related to the features or resolution compatible with the user device 120, known at the platform 110 (e.g., by provisioning, receipt of broadcast information, or by polling the user device 120). The platform 110 can tailor the features for encoding based on a type of the user device 120 (e.g., smartphone, VR goggles, etc.) and its respective capabilities.

The method 400 can include applying (415) security levels to one or more features, groups or collections of features. In another embodiment of the method, a level of security is applied to sections of the file or the entire file itself, as described above. The security levels can include watermarks (e.g., FIG. 3) embedded in the data or other encryption (e.g., encryption key) that can limit the types of devices or identity of devices able to decode the data files (see above description of security).

The method 400 can further include encoding (420) the plurality of features based on the indication (410) and the security levels (415). The encoding can be based specifically on the capabilities and characteristics of user device 120.

In some other embodiments, instead of encoding (420) specific files every time, the method 400 can include selecting a saved file (e.g., in memory) that satisfies the indication (410) and the security levels (415). This can further save processing and eliminate redundant steps in transmitting appropriate encoded files/data.

In some embodiments, the method 400 can change the content of the encoded file based on limitations (425) at the user device 120. Such limitations can include reduced connectivity or processing power, for example. In such a case, should performance of the steps of the method 400 be interrupted, the method 400 can return to the identification (405) of the applicable list of features needed for encoding the files.

If there are no further limitations (425), the method 400 can proceed to rendering (430) the 3D virtual object or environment for display at the user device 120. The rendering (430) can include a 3D modeling program decoding the encoded file, and using the content of the decoded file to render the virtual object for display to a user with all of the features.

In some embodiments, the steps of the method 400 can be performed by processors or a server associated with the platform 110 or the processors 126 of the user device 120. In some embodiments, some steps of the method 400 can be omitted or performed out of the specified order as required by system architecture.

Different applications benefit from a single file, including the following applications:

Virtual/Alternate Reality: Complex and intricate objects immerse users in their environments. A virtual object's geometry, appearance, scene, and animation is all contained in a single file, which simplifies the process of importing and exporting files to avoid searching for and importing multiple files.

Automotive Design: Having a single file containing all information about a virtual model is easier to share and import. Engineers and designers collaborate on virtual objects in product development. A single file containing a detailed virtual model is easy to share across collaborating groups and industries.

Aerospace Engineering: This industry values detailed and precise objects. A single file contains all the necessary information to precisely alter a model's design and accurately simulate tests. Ability to encode both approximate and precise meshes in one file increases efficiency in during the development process from object design to simulated tests. In addition, security levels within the code is appealing to aerospace manufacturers who design extremely complex and secret models.

Pharmaceutical Development: A single file allows designers to access all levels of a virtual object's detail and complexity. Rather than settle for colorless, rigid models or manage multiple files, chemical engineers can import and encode all desired information into a single file extension. Interacting with a complex, detailed model enhances the design process for engineers.

Architecture and Construction: The ability to view and interact with detailed models of possible structural designs is vital to any engineer and architect. A single, all-encompassing file extension allows users to view the different levels of details in any virtual object at any time.

### Other Aspects

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120) or otherwise known in the art. Systems that include one or more machines or the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

What is claimed is:

1. A method for encoding features of a three-dimensional (3D) virtual object, the method comprising:
receiving an indication of one or more features of a plurality of features required for rendering the virtual object at a user device communicatively coupled to the server;
applying, by the server, security levels to the plurality of features, the security levels comprising one or more encryption types;
encoding a data file based on the indication and the security levels, the file including data related to multiple resolution levels of the one or more features; and
causing the virtual object to be rendered at the user device based on the file and operating characteristics of the user device.

2. The method of claim 1, wherein the indication comprises a selection of the one or more features from a user device.

3. The method of claim 1, wherein the indication comprises a selection at the server based on the operating characteristics of the user device.

4. The method of claim 1, wherein the plurality of features comprises one or more of geometry, appearance, scenery, and animation features of the virtual object.

5. The method of claim 1, wherein the plurality of features comprises one or more of an approximate mesh, a precise mesh, constructive solid geometry, color, texture, material, lighting information, scenery, kinematics, and movement of the virtual object.

6. The method of claim 1, wherein the file is compatible across multiple user devices.

7. A non-transitory computer-readable medium comprising instructions for encoding features of a three-dimensional (3D) virtual object that when executed by one or more processors cause the one or more processors to:
receive an indication of one or more features of a plurality of features required for rendering the virtual object at a user device communicatively coupled to the server;
apply, by the server, security levels to the plurality of features, the security levels comprising one or more encryption types;
encode a data file based on the indication and the security levels, the file including data related to multiple resolution levels of the one or more features; and
cause the virtual object to be rendered at the user device based on the file and operating characteristics of the user device.

8. The non-transitory computer-readable medium of claim 7, wherein the indication comprises a selection of the one or more features from a user device.

9. The non-transitory computer-readable medium of claim 7, wherein the indication comprises a selection at the server based on the operating characteristics of the user device.

10. The non-transitory computer-readable medium of claim 7, wherein the plurality of features comprises one or more of geometry, appearance, scenery, and animation features of the virtual object.

11. The non-transitory computer-readable medium of claim 7, wherein the plurality of features comprises one or more of an approximate mesh, a precise mesh, constructive solid geometry, color, texture, material, lighting information, scenery, kinematics, and movement of the virtual object.

12. The non-transitory computer-readable medium of claim 7, wherein the file is compatible across multiple user devices.
